(19) United States
(12) Patent Application Publication
(10) Pub. No.: US 2004/0196805 A1
(43) Pub. Date: Oct. 7, 2004

(54) Combined selective time switching transmission deversity (ststd) method and system

(76) Inventor: Xiaoyang Lee, Monmouth Junction, NJ (US)

Correspondence Address: RATNERPRESTIA, P O BOX 980, VALLEY FORGE, PA, 19482-0980, US

(21) Appl. No.: 10/473,732

(22) PCT Filed: Mar. 30, 2001
(86) PCT No.: PCT/US01/10283

(51) Int. Cl. H04Q 7/00

(52) U.S. Cl. 370/329; 370/341

(57) ABSTRACT

A common channel transmitter at the base station produces a first carrier signal to sequentially communicate, via diverse transmission antennas, a pilot reference signal to mobile stations. A dedicated channel transmitter produces a second carrier that communicates voice and signal traffic to the mobile station. At the base station a sequencing switch sequentially couples the common channel transmitter to each of the transmission antennas for sequentially transmitting the first carrier modulated with a pilot reference signal. A plurality of diverse receiving antennas, each corresponding to a respective one of the transmitter antennas, receive signals from the mobile station. The base station receiver provides respective signal to noise estimations indicating one of the antennas has a signal to noise value that is better than the signal to noise value provide by any other antenna. The base station uses this antenna for the dedicated channel that is transmitted to the mobile station.

### FIELD OF THE INVENTION

The present invention relates in general to communications systems and more particularly to an efficient method for implementing transmission diversity in such a telecommunications system.

### BACKGROUND OF THE INVENTION

An important aspect of wireless communications is transmission diversity. Enhancements in transmission diversity can create performance improvements that allow information transmitted via the air channels to be less affected by environmental conditions. This is especially true for a Code Division Multiple Access (CDMA) wireless communications system.

Many transmission diversity techniques have been proposed in CDMA systems, such as: orthogonal transmission diversity (OTD), time switching transmission diversity (TSTD), space-time switching diversity (STS).

In a conventional wireless communication system, a base station, or fixed station, is used for communicating with mobile stations. Base stations are also referred to as a cell, a sector within a cell, or a mobile switching center. Base stations for conventional wireless communication systems presently use a dedicated pilot reference signal channel, that is an individual pilot reference signal for each transmitting antenna. A pilot reference signal channel is an unmodulated, direct-sequence spread spectrum signal transmitted continuously by each CDMA base station. The pilot reference signal channel allows a mobile station to acquire the timing of the forward CDMA channel, provides a phase reference for coherent demodulation. The pilot signal also provides a means for signal strength comparisons between base stations to determine when to handoff or transfer control of a mobile station from one base station to another.

The CDMA2000 direct spread forward link (or forward traffic channel used to transport service options such as voice and signaling traffic from a base station to a mobile station) employs OTD to improve the forward link performance. OTD is implemented by transmitting signals of forward link channels for the same user by splitting coded bits into two (or more) data streams. These coded bit streams may be transmitted through two (or more) separate antennas after being spread by different Walsh codes. Walsh codes are a set of waveforms, that have the characteristic of being orthogonal to each other. Two codes are orthogonal if they have a zero cross product when summed over the full period of codes. The spread sequences are scrambled by a quadrature pseudo-noise (PN) sequence, which is the same for all the users of the same sectors. Thus, orthogonality is maintained between the two output streams, and hence same-cell interference is substantially eliminated. By splitting the coded data into two or more separate data streams, the effective number of spreading codes per user is the same as the case without OTD.

In the case of two transmission antennas, one exemplary method of assigning Walsh codes to different antennas is as follows. Assuming that, without transmission diversity, Walsh code Wk of length 2ₘ is assigned for a certain data rate, with transmission diversity, the coded bit stream is split in to two and the coded bit rate of each antenna is reduced to half of the original rate. As a result, each of the bit streams is spread by Walsh codes of length 2ₘ₊₁. These codes may be constituted from Wk by forming [Wk+Wk] and [Wk−Wk]. The length of Wk is defined in this section as the Walsh code length. It should be noted that different orthogonal pilot reference signals are transmitted over different antennas. In other words, the common pilot reference signal is transmitted over one antenna and a diversity pilot reference signal is transmitted over the second antenna. This allows coherent detection of the signals received from both antennas.

Time diversity is a technique common to most digital transmission systems. CDMA systems use a number of forward error correcting codes after which the signals are spread in time by use of interleaving. By separating the pieces of data over time, a sudden disruption in the CDMA data does not cause a corresponding disruption in the voice signal. When the frames are pieced back together by a decoder, any disrupted voice data is in small pieces over a relatively long stretch of actual speech, reducing the impact on the voice quality. Forward error correction is applied, along with maximal likelihood detection to correct disrupted data. The particular scheme used for CDMA is convolutional encoding in the transmitter with Viterbi decoding using soft decision points in the receiver. For years, convolutional coding with Viterbi decoding has been the predominant forward error correction technique used in space communications, particularly in geostationary satellite communication networks.

Related to time diversity is path diversity. Path diversity comes about because there is more than one path of varying distance from the transmitter to the receiver. Multiple versions of the same signal are present at the receiver which have arrived via different paths and are time shifted with respect to each other. CDMA takes advantage of the multipath by using multiple receivers to lock on to, for example, the three strongest received multipath signals, time shifts them into alignment and then sums them together to produce a signal that is better than any of the individual signal components. The multiple receiver correlation system is called a rake receiver.

In order to receive signals that exhibit time diversity and path diversity, receivers typically use diversity antennas. The term “diversity antennas” means a group of antennas each of which exhibits a distinct transmit or receive characteristic. The exemplary embodiment of the invention focuses on two types of diversity: space diversity and polarization diversity.

Space Diversity refers to the use of two receiving antennas separated by some physical distance, usually on the order of several wavelengths, feeding individual receivers the outputs of which are combined. This system overcomes the problems of multi-path fading because fading affects the spaced antennas differently. The principle of space diversity recognizes that when a mobile transceiver is moving about, it traverses a pattern of signal peaks and nulls. When one of the nulls falls on one antenna it causes the received signal strength to drop. However, if a second antenna is placed some distance away, it may be outside of the signal null area and thus receive the signal at an acceptable signal level.

Another type of antenna diversity concerns the polarization of the antenna. It is well known that antennas may be polarized vertically, horizontally, elliptically or circularly. Typically, signals are received best when the polarization of the receiving antenna matches the polarization of the transmitting antenna. The use of antennas having a particular polarization allows the receiver to avoid interference from noise sources that inherently impart different polarization vectors to the noise signals that they produce. Thus, the signal-to-noise ratio for a received signal may be diversified by using groups of antennas that simultaneously transmit signals having respectively different polarization vectors to corresponding receiving antennas.

For all the present proposals, all of the antenna diversity techniques in a CDMA system require a dedicated diversity pilot reference signal for each diverse signal that is transmitted. The transmitted signals are either separated into multiple data streams, such as in the OTD system, or split and applied on all antennas at the same time. For space diversity and polarization diversity, the receiver may combine the received signals from all antennas with different fading paths and recover the received signals correctly. These transmission techniques with the use of dedicated pilot reference signals on each diversity antenna have solved the issues regarding the utilization of transmission diversity to overcome the channel fading problems. The dedicated pilot reference signals generate, however, large overhead costs because they are continuously transmitted by all of the antennas with sufficient power level to ensure all the receivers within the system coverage can recover the signals from different antennas correctly. In addition, the complexity and equipment cost for both the transmitter and receiver are increased greatly by the use of dedicated diversity pilot reference signal. Therefore, it would be beneficial if there were a method to reduce the system overhead costs associated with antenna diversity and still provide transmission diversity.

### SUMMARY OF THE INVENTION

The present invention discontinues the use of a dedicated pilot reference signal for each transmitting antenna and instead sequentially switches i.e., connects and disconnects, a pilot reference signal to each transmitting antenna of the base station. This invention has all the advantages of the conventional technique of individual pilot reference signal tones for each antenna and it has none of the above described disadvantages. The invention resides in attaining the same results as the conventional technique but with less equipment complexity and lower equipment and maintenance costs. The exact nature of this invention as well as other objects and advantages thereof will be readily apparent from consideration of the following specifications relating to the annexed drawings in which:

### BRIEF DESCRIPTION OF THE DRAWINGS

The FIG. 1 depicts a base station in communications with a mobile station using a time shared pilot reference signal generator.

FIG. 2 is a process flow diagram for the transmission of the first carrier.

FIG. 3 is a process flow diagram of the Mobile Station Receive process.

FIG. 4 is a process flow diagram of the Mobile Station Call process.

FIG. 5 is a process flow diagram of the Base Station receive and second carrier transmit process.

### DETAILED DESCRIPTION OF THE INVENTION

FIG. 1 shows an exemplary embodiment, of a Selective Time-Switching Transmission Diversity (STSTD) system according to the present invention for a wireless communication system 100. This system does not require a dedicated pilot reference signal for each antenna as in present wireless telecommunications systems. As shown in FIG. 1 only one pilot reference signal 111 is used, for multiple transmitting antennas 118, 128, and 138.

The exemplary CDMA wireless communication technology uses a set of communication channels to communicate between a base station 102 and a mobile station 140. Communications channels are categorized as having forward channels and reverse channels. In the exemplary CDMA system, all CDMA channels are differentiated by which Walsh code they use and they are carefully chosen to be orthogonal to each other. By definition transmission signals 119, 129, and 139, because they being transmitted from the base station 102 to the mobile station 140, are propagated in forward channels. Also by definition, transmission signal 144, because it is being transmitted from the mobile station 140 to the base station 102, is propagated in a reverse channel.

The forward channel for all of the signals 119, 129, and 139 from the base Station 102 is typically a composite of a minimum of four channels. The four channels are a pilot channel, a sync channel, a paging channel, and a traffic channel. The pilot channel is unmodulated; it consists only of an unmodulated carrier signal spread by the final spreading sequence (short sequences). The mobile station 140 linked to the base station 102 uses the pilot channel as a coherent phase reference. The pilot channel allows mobile station 140 to acquire the timing of the forward CDMA channel, provides a phase reference for coherent demodulation, and provides a means for signal strength comparisons among multiple base stations, allowing the base stations to determine when to handoff or transfer control of the mobile station from one base station to another. The other three forward channels, the sync channel, the paging channel, and the traffic channel, use the same data flow, but different data are sent on the channels. The sync channel transmits time of day information to allow the mobile station 140 and the base station 102 to align their clocks which are used to form the basis of the codes that are used by both to make a link. The paging channel is a digital control channel for the forward channel. The traffic channel is equivalent to an analog voice channel and is where the actual conversations takes place. The forward traffic channel, in addition to voice, also carries the mobile power control information from the base station 102 to the mobile station 140. In conventional CDMA systems, the pilot channel, the sync channel, the paging channel and the traffic channel all modulate a common carrier signal. The separate channels are formed by the respective Walsh codes. In CDMA 2000, however, the common channels (pilot, sync and paging) may modulate a carrier signal having a different frequency than the carrier signal modulated by the traffic channel.

The reverse channels typically include at least two channels. Transmission signal 144, because it is transmitted from the mobile station 140 to the base station 102, is propagated in the reverse channels. The two reverse channels are the access channel, and the reverse traffic channel. The access channel is a digital control channel. Communication on the access channel includes registration requests, responses to pages, and call origination. The traffic channel is equivalent to the analog voice channel, it carries the voice and mobile power control information from the mobile station 140 to the base station 102.

Some of the channels described above are referred to as dedicated channels because they are dedicated for use during some period by a particular mobile station user to carry voice information or data information peculiar to the user. Other channels described above are considered to be common channels because they are shared by multiple users in the system such as for broadcasting, control channels, etc. The present embodiment of the STSTD transmission diversity technique shown in FIG. 1, concerns both the dedicated and common channels.

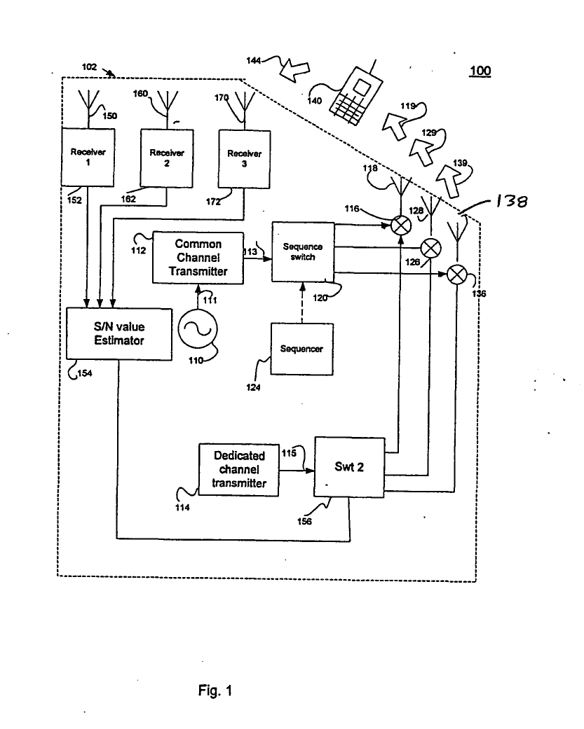

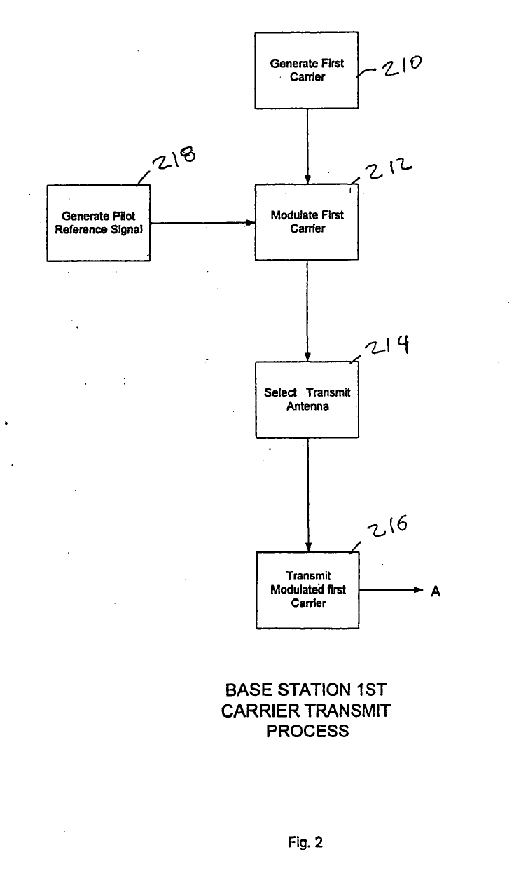

In applicant's invention, when the STSTD transmission diversity method is used in the base station side with multiple transmitting antennas 118, 128, and 138 and receiving antennas 150, 160, and 170 the process illustrated in FIG. 2 occurs. At step 210, a common channel transmitter 112 produces a first carrier signal 113, comprising a radio frequency signal modulated with a pilot channel spreading signal. At step 212, first carrier 113 is used to communicate a pilot reference signal 111, generated at step 218, from the base station 102 to at least one mobile station 140. The common channel transmitter 112 is modulated with the pilot reference signal 111 and produces a first carrier signal 113 which, at step 214 is sequentially connected through a sequencing switch 120 to each of the plurality of transmitting antennas 118, 128, and 138 of a first antenna group. The sequencing switch, at step 216, selects one antenna at a time for to transmit the common channel signals.

In the exemplary embodiment of the invention stepper motor 124 controls sequencing switch 120 which interchanges and connects the output of common channel transmitter 112 sequentially to couplers 116, 126 and 136 and, thus, to the respective transmitter antennas of the first antenna group. Alternatively, a multiplexer may be used to switch the pilot signal among the transmitter antennas 118, 128 and 136. In the exemplary embodiment of the invention, the antennas are switched with a switching speed of 1.25 milliseconds. It is contemplated that the switching speed may be greater than or equal to 1.25 milliseconds.

As shown in FIG. 1 of applicant's exemplary embodiment because there is only one transmitting antenna either 118, 128, or 138 used at a time by the common channel transmitter, there is no need to maintain a dedicated diversity pilot reference signal generator 110 for each transmitting antenna.

Thus, transmission diversity is achieved by using different antennas at different time intervals. Applicants embodiment obtains better diversity using a combination of time domain diversity, space diversity and polarization diversity, while sending only one pilot signal. Eliminating the other dedicated diversity pilot reference signals, reduces the system complexity of both the transmitter and receiver sides. In addition, it decreases the level of noise for other signals to be transmitted in the same frequency band. Eliminating the other dedicated diversity pilot signals also increases the capacity of the system.

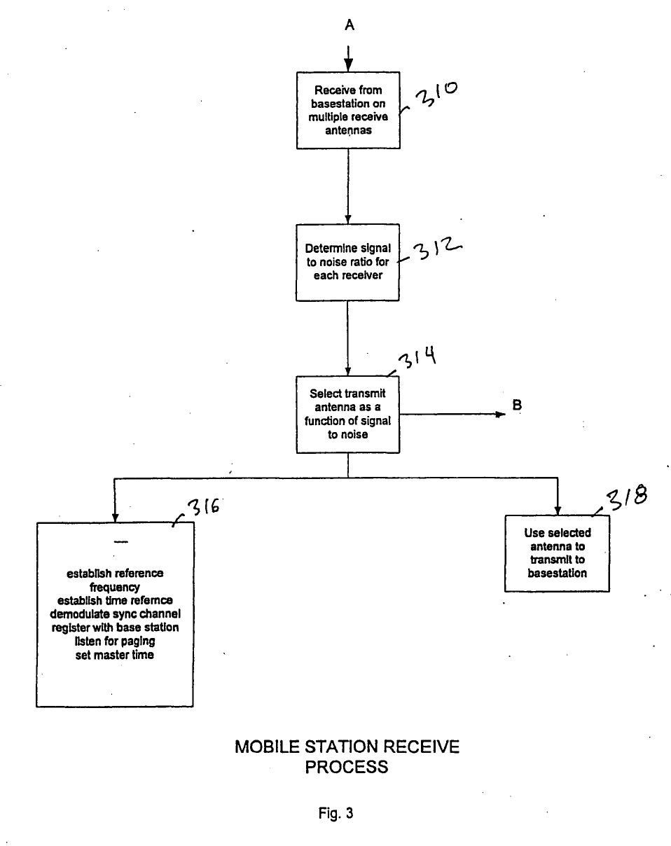

Transmitter signals 119, 129, and 139 are sequentially transmitted through the airways where they are received by mobile station 140. FIG. 3 illustrates the receive process for mobile station 140.

Mobile station 140 may contain a multiple element antenna array that can achieve significant diversity gain and interference rejection. Mobile station 140 can recover the common channel pilot signal even though it is being sequentially switched among the antennas 118, 128 and 138 by using phase estimation based on an average common pilot reference signal received from the base station 102.

The process shown in FIG. 3 illustrates that the transmitter antenna that is to be used by the mobile station is determined by calculating the signal to noise levels for the respective receive antennas and, based on the receive antenna providing the best signal to noise value, using the corresponding transmit antenna to send the dedicated channel signal back to the base station. All of the antennas of the mobile station receive the signals from the base station at the same time, at step 310. At step 312, the process calculates a figure of merit to compare the received signals. Based on the comparison, step 314 selects the transmit antenna that corresponds to the best-performing receive antenna. After step 318, the process splits. Step 318 identifies the selected transmit antenna as the one to be used to transmit signals to the base station, while step 316 processes the signal received on the common channel to establish a reference frequency, a time reference, demodulate the synchronization channel, listen for a paging signal, set the master time value and receive an acknowledgement that the remote receiver has been registered with the base station.

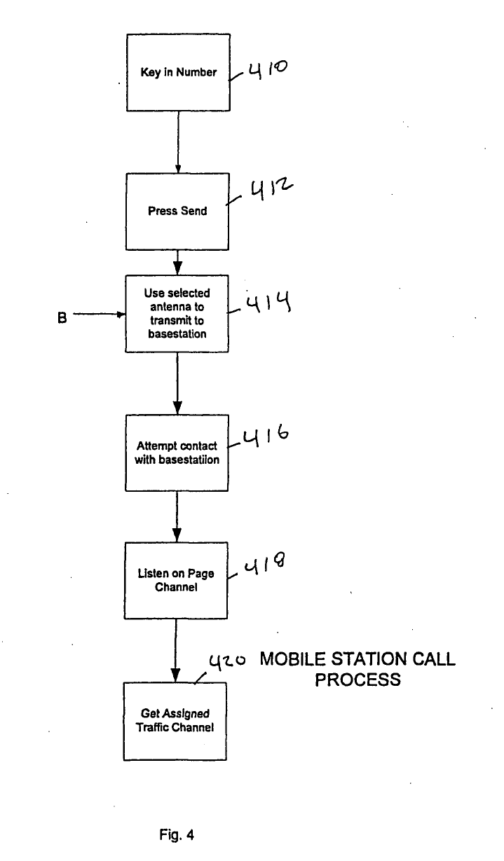

The mobile station call process is shown in FIG. 4. After dialing the desired number, at step 410 and pressing the send key at step 412, the transmit antenna selected at step 314 of FIG. 3, is used, at step 414 to transmit the call request signal to the base station. The exemplary system uses all of the receive antennas to listen for the paging signal from the base station at step 416, extracts the assigned channel information from the paging signal at step 418, and transmits the dedicated channel information on the assigned traffic channel at step 420.

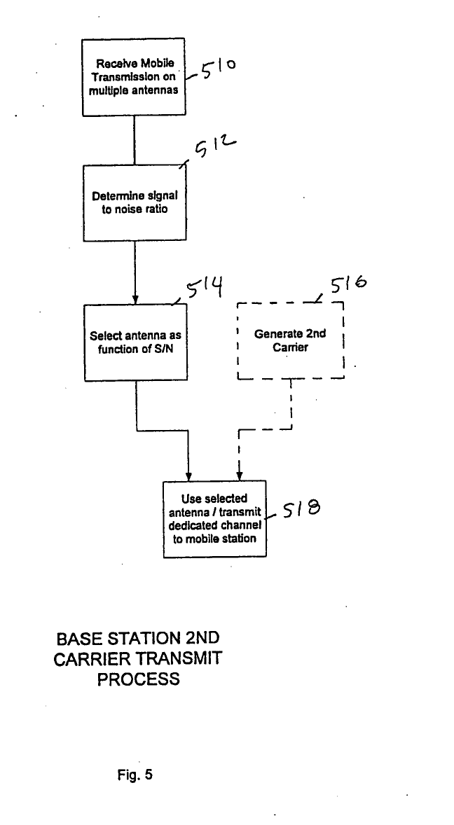

Referring to FIG. 1 and FIG. 5, the transmitted signal 144 from mobile station 140 is simultaneously received, at step 510, by all of the antennas in a second antenna group located at the base station. This second antenna group includes the receiving antennas 150, 160, and 170 each corresponding to a respective one of the transmitter antennas 118, 128 and 138. The base station receives this signal and determines which antenna to use to send the dedicated channel signal from the base station to the mobile station.

In the base station 102, a dedicated channel transmitter 114 optionally produces a second carrier signal 115, at step 516, as indicated by step 516 being shown in phantom. The dedicated channel is used to communicate voice and signal traffic from the base station 102 to at least one mobile station 140. If the CDMA system is a conventional CDMA system, step 516 does not produce a second carrier signal, because the carrier signal used for the dedicated channel is the same as the carrier signal used for the common channels. For CDMA 2000 systems, however, step 516 may produce a second carrier signal having a different frequency than the first carrier signal.

Dedicated channel transmitter 114 is connected to one of the transmission antennas 118, 128, or 138. The selection of which antenna to use is determined after reception at step 510 of transmitted signal 144 from mobile station 140, by receivers 152, 162, and 172. The next step in the process, step 512, processes each of the received signals, in signal to noise estimator 154, to generate respective estimates of their signal to noise ratios (SNRs). The signal to noise values are used by the S/N value estimator 154 to select one of the transmit antennas 118, 128 and 138 to be used to transmit the dedicated channel signal to the remote station 140. As with the process shown in FIG. 3, the process shown in FIG. 4 selects the transmit antenna that corresponds to the receiving antenna having the highest signal to noise value.

While this invention has been described with reference to specific embodiments, it is not necessarily limited thereto. Accordingly, the appended claims should be construed to encompass not only those forms and embodiments of the invention specifically described above, but to such other forms and embodiments as may be devised by those skilled in the art without departing from its true scope.

What is claimed:

1. A communication system for implementing transmission diversity among a base station and at least one mobile station, the communication system comprising:
a common channel transmitter for producing a first carrier signal which communicates a pilot reference signal from the base station to the at least one mobile station;
a plurality of transmitting antennas configured to transmit said first carrier signal, each of the plurality of transmitting antennas having a respectively different transmission characteristic; and
a pilot reference signal sequencing switch which sequentially couples said common channel transmitter to each of the plurality of transmitting antennas of said transmit antenna group.

2. A communications system according to claim 1, wherein at least two of the plurality of transmitting antennas exhibit spatial diversity.

3. A communications system according to claim 2, wherein at least two of the plurality of transmitting antennas exhibit polarization diversity.

4. A communications system according to claim 1, wherein the pilot reference signal switching means includes a stepper motor that switches among the plurality of transmitting antennas with a switching speed of greater than or equal to 1.25 milliseconds.

5. A communications system according to claim 1, wherein the pilot reference signal switching means includes a multiplexer that switches among the plurality of transmitting antennas with a switching speed of greater than or equal to 1.25 milliseconds.

6. Apparatus for selecting one transmitter antenna from among a plurality of transmitter antennas, the one transmitter antenna to be used by a dedicated channel transmitter to transmit a dedicated channel signal to at least one mobile station, the apparatus comprising:
a plurality of receiving antennas each corresponding to a respective one of the transmitter antennas for receiving signals from the at least one mobile station;
a receiver located at the base station configured to receive the signals from at least two antennas of the plurality of receiving antennas and for providing respective signal to noise estimations indicating that one antenna of at least two antennas has a signal to noise value that is better than the signal to noise value provided by any other antenna of at least two antennas; and
a controller coupled to the output of said receiver for using the signal to noise estimation to connect, to the dedicated channel transmitter, one of the plurality of transmitting antennas corresponding to the one of the plurality of receiving antennas having the highest signal to noise value.

7. Apparatus according to claim 6, wherein at least two of the plurality of receiving antennas exhibit spatial diversity.

8. Apparatus according to claim 7, wherein at least two of the plurality of receiving antennas exhibit polarization diversity.

9. A method for implementing transmission diversity among a base station and at least one mobile station, the method comprising the steps of:
generating a carrier signal which communicates a pilot reference signal from the base station to the at least one mobile station; and
sequentially switching the carrier signal among a plurality of transmit antennas, each transmit antenna providing a respectively different transmission characteristic.

10. A method according to claim 9, wherein the step of sequentially switching the carrier signal among the plurality of transmit antennas includes the step of sequentially switching the carrier signal among ones of the plurality of transmit antennas that exhibit spatial diversity.

11. A method according to claim 9, wherein the step of sequentially switching the carrier signal among the plurality of transmit antennas includes the step of sequentially switching the carrier signal among ones of the plurality of transmit antennas that exhibit spatial diversity and polarization diversity.

12. A method for selecting one transmitter antenna from among a plurality of transmitter antennas, the one transmitter antenna to be used to transmit a dedicated channel signal to at least one mobile station, comprising:
receiving at least one signal from at least one mobile station at each of a plurality of receiving antennas, each receiving antenna corresponding to a respectively different one of the transmitter antennas;
estimating a respective signal to noise value for the signals received by each of the receiving antennas, and identifying the signal to noise value for one of the receiving antennas as being better than the signal to noise value of any other antenna of at least two antennas; and
selecting as the transmit antenna on which to send the dedicated channel signal, the transmit antenna corresponding to the receiving antenna having the identified signal to noise value.

13. A method according to claim 12, wherein the step of receiving the at least one signal at each of the plurality of receiving antennas receives the at least one signal at antennas having respectively different spatial characteristics.

14. A method according to claim 13, wherein the step of receiving the at least one signal at each of the plurality of receiving antennas receives the at least one signal at antennas having respectively different polarization characteristics.
